(19) United States
(12) Patent Application Publication
(10) Pub. No.: US 2010/0039883 A1
(43) Pub. Date: Feb. 18, 2010

(54) LAB STIRRER

(75) Inventors: Roman Foltyn, Ruckersdorf (DE); Markus Beck, Neumarkt (DE); Walter Lohmann, Wendelstein (DE); Achim Melching, Schwabach (DE)

Correspondence Address: GIFFORD, KRASS, SPRINKLE,ANDERSON & CITKOWSKI, P.C, PO BOX 7021, TROY, MI, 48007-7021, US

(73) Assignee: HANS HEIDOLPH GmbH & Co. KG

(21) Appl. No.: 12/540,415

(22) Filed: Aug. 13, 2009

(30) Foreign Application Priority Data
Aug. 13, 2008 (DE) 10 2008 038 833.5

(51) Int. Cl. B01F 15/00; G01K 13/00

(52) U.S. Cl. 366/142; 374/141; 374/E13.001

(57) ABSTRACT

The invention relates to a lab stirrer, in particular to an overhead stirrer, having a stirring unit and having a stirring member which can be rotatingly driven by the stirring unit and is provided for immersion into a medium to be stirred, with the stirring member being provided with at least one measurement sensor for the measurement of measurement data of a measurement parameter of the medium. The stirring member is provided with a measurement circuit which includes a data transmission device to transmit the measurement data in a contactless manner to a receiver unit not rotating with the stirring member.

### CROSS-REFERENCE TO RELATED APPLICATION

This application claims priority of German Patent Application 10 2008 038 833.5 filed Aug. 13, 2008.

### FIELD OF THE INVENTION

The present invention relates to a lab stirrer, in particular to an overhead stirrer, having a stirring unit and having a stirring member which can be driven in a rotating manner by the stirring unit and is provided for immersion into a medium to be stirred.

### BACKGROUND OF THE INVENTION

Lab stirrers having a stirring unit are used in laboratories to stir a medium located in a container. In chemical research, for example, a medium is stirred by means of a stirring tool located at a stirring shaft to achieve a uniform substance distribution. The medium to be stirred can in particular be (particulately) solid or liquid. Solid substances can, for example, be dissolved in liquids or different liquids can be mixed with one another. For this purpose, a so-called overhead stirrer is frequently used in which the stirring unit is arranged above the container and the stirring shaft with the stirring tool extends vertically downwardly.

In addition to a uniform substance distribution, a uniform temperature distribution within the medium should also be achieved by the stirring process. This is in particular of importance when the medium is temperature treated, for example heated, during the stirring. In this respect, the temperature of the medium to be stirred, in particular of a liquid, is measured during the stirring process. For this purpose, a temperature sensor is as a rule immersed into the medium and the temperature is determined with it.

Many mixing or stirring processes take place in closed containers. The stirring shaft must be introduced into the closed container or into the closed stiring vessel through a passage. The temperature sensor required for the temperature measurement is guided through an additional passage. This results in increased costs for the containers and makes the handling more difficult.

The term “stirring” in the sense of the invention also includes the mixing, homogenization, suspension, gassing and circulation of media. Only stirring without any restriction is spoken of in the following.

It is the object of the present invention to avoid the disadvantages of the lab stirrers known from the prior art.

### SUMMARY OF THE INVENTION

The present object is satisfied by a lab stirrer having the features of claim 1 and in particular in that the stirring member is provided with at least one measuring sensor for the measurement of measurement data of a measurement parameter of the medium, with the stirring member being provided with a measurement circuit which includes a data transmission device to transmit the measurement data in a non-contact manner to a receiver unit not rotating with the stirring member.

The lab stirrer in accordance with the invention has the advantage that no additional or separate measurement sensor is necessary for the measurement of the measurement parameter of the medium to be stirred or mixed since the stirring member is already provided with a measurement sensor. Consequently, no separate holder has to be provided for the measurement sensor. The handling of a lab device which includes the lab stirrer and a container comprising the medium to be stirred or mixed is simplified since no additional or separate sensor has to be provided. It is furthermore precluded that the sensor is damaged by a stirring element or a stirring tool of the stirring member, for example by one or more stirring vanes, or that the sensor hinders the stirring member.

If the stirring or mixing of the medium takes place inside a closed container or vessel, the container does not have to have any additional passage. The fewer passages the container has, the more cost-effectively the container can be manufactured and the more simple the handling of the container during the stirring process, including the filling and the emptying of the container.

The measurement sensor can be integrated into the stirring member. The measurement sensor can, for example, be attached to the stirring member at the outside or arranged inside the stirring member. The measurement sensor is in particular carried by the stirring member. For example, the medium to be stirred can be a liquid, or also other media such as high viscosity media, gases, gels or powdery substances.

Generally, the present invention can be realized with any desired stirrer or any desired stirring apparatus.

The stirring member is provided with a measurement circuit which is in particular connected to the measurement sensor and which includes a data transmission device to transmit the measurement data to a receiver unit not rotating with the stirring member, with the measurement data being able to be transmitted to the receiver unit by the data transmission device. The measurement data can be processed and/or digitized in the measurement circuit. The receiver unit is preferably part of the Tab stirrer and/or is arranged in a fixed position, stationary or fixed to the housing in the lab stirrer. Energy and/or data are preferably able to be transmitted from a coupling device, in particular the receiver unit or a coupling device of the receiver unit, to the measurement circuit. Generally, however, an energy supply rotating with the stirring member can also be provided for the measurement sensor and/or for the measurement circuit.

The measurement data can be transmitted from the data transmission device to the receiver unit in a contactless or contactfree manner. Alternatively, the measurement data can also be transmitted in a non-contactless or in a non-contactfree manner, for example by means of a sliding ring or a sliding contact. In this case, in particular no measurement circuit such as was described above is necessary. The energy and/or the data can also preferably be transmitted from the coupling device to the measurement circuit in a contactless manner. Sliding rings or sliding contacts prone to wear can be avoided by the non-contact transmission of the measurement data, of the energy and/or of the data so that a reliable and safe transmission and an operation free of service in this respect are possible.

### BRIEF DESCRIPTION OF THE FIGURES

The invention will be explained in more detail in the following with reference to preferred embodiments shown in the Figures. The special features shown therein can be used individually or in combination to provide preferred embodiments of the invention. The embodiments described do not represent any restriction of the general quality of the subject matter defined in the claims. There are shown:

FIGS. 1a to c different embodiments of the lab stirrer in accordance with the invention;

FIG. 2 a section through a stirring shaft of the lab stirrer with integrated measurement circuit;

FIG. 3 a detailed drawing of an end of the stirring shaft of FIG. 2;

FIG. 4 a cut-away schematic diagram of the stirring shaft of FIG. 2 and of a receiver unit; and

FIGS. 5a, b schematic block diagrams of a measurement circuit and of the receiver unit of FIG. 4.

### DETAILED DESCRIPTION OF TEE PREFERRED EMBODIMENTS

The stirring unit preferably includes a holder which can be rotatingly driven by a drive unit for the holding of the stirring member, in particular during stirring, with the holder being made for the changeable holding of the stirring member. The drive unit is preferably arranged inside a stirring unit housing.

The lab stirrer is in particular adapted to the use with containers in lab scale. The lab stirrer is preferably suitable or provided for the stirring of volumes of up to 2001, in particular up to 1001, in particular up to 501, in particular up to 251, in particular up to 10, in particular up to 51, in particular up to 31, in particular up to 1.51. A container receiving the medium to be stirred can in particular have a capacity with the named volumes.

Any measurement sensor which can measure measurement data of a measurement parameter of the medium directly or indirectly is generally suitable to realize the invention. The stirring member can in particular be provided with a plurality of measurement sensors, in particular of different types. The at least one measurement sensor is preferably a temperature sensor for the measurement of the temperature of the medium or of the temperature distribution within the medium. The measurement data determined are then temperature data which are determined by the temperature sensor. Temperature sensors used in the lab area are usually made as resistance sensors. A sliding contact has the property that it has varying resistance values—depending on the state and degree of wear. A contactless measurement data transmission is therefore particularly advantageous with respect to the measurement accuracy of the sensor in the case of a temperature sensor provided at the stirring member.

Alternatively or additionally to the temperature, however, one or more other measurement parameters of the medium can also be measured. The measurement sensor or one of the measurement sensors can, for example, include a strain gauge to determine the torque of the stirring member via which in particular the viscosity of the medium can be measured. The strain determined is in this respect an intermediate parameter of the measurement parameter of the viscosity of the medium. Further sensor types are additionally conceivable. For example, the stirring member can be provided with a measurement sensor for the measurement of the conductivity of the medium or of the pH of the medium, with the respective measurement sensor being contacted, in particular flowed around, by the medium in the pH measurement. For this purpose, the stirring member can have openings such as slits or bores, in particular in the region of the measurement sensor.

To obtain a particularly compact lab stirrer, the receiver unit and the stirring unit can be arranged in a common housing. The measurement sensor can be arranged at the end of the stirring member provided for immersion into the medium to be stirred.

In accordance with another embodiment of the invention, the stirring member includes a stirring shaft, with the stirring shaft preferably being made as a hollow shaft in whose interior the measurement sensor is arranged. Alternatively or additionally to the measurement sensor, the aforesaid measuring circuit can also be arranged in the interior of the hollow shaft. The stirring member can additionally include a stirring element, in particular one or more stirring vanes, with the stirring element preferably being replaceably fastenable to the stirring shaft. The changeability or replaceability of the stirring element allows an adaptation of the lab stirrer, for example, to the stirring job or to the viscosity of the medium.

The data transmission device is preferably made for the digital transmission of the measurement data, If the measurement data are already digitized in the measurement circuit, the digital data can be transmitted from the data transmission device to the receiver unit in digital form. In this manner, a robust and less error-prone transmission can be carried out.

The measurement circuit can include a coil for the transmission of the measurement data and/or for the reception of the energy and/or of the data. The coil is preferably provided at the end of the stirring member disposed opposite the end provided for immersion into the medium to be stirred, The stirring member is furthermore preferably made of a non-magnetic material in the region of the coil. In particular in the case that the transmission of the measurement data by means of load modulation is provided, the coil can cooperate with a magnetic field which is generated by the receiver unit. The stirring member can be insertable into a holder for the holding of the stirring member such that its region having the coil, in particular its end having the coil, projects beyond the holder in the axial direction.

The receiver unit can include a coil for the generation of a magnetic field for the reception of the measurement data and/or for the transmission of the energy and/or of the data. The coil is preferably connected to feed current electronics for the generation of an alternating magnetic field, said feed current electronics feeding alternating current into the coil. The use of an alternating magnetic field makes it possible that the energy and/or the data can also be transmitted to the measurement circuit when the stirring member and/or the measurement circuit is stationary, i.e. when there is no relative movement between the respective transformer or transmitter and the respective receiver.

The measurement data can be able to be transmitted inductively, in particular by means of load modulation, from the data transmission device to the receiver unit. Alternatively to this, the measurement data can, however, also be able to be transmitted optically from the data transmission device to the receiver unit, with the data transmission device including a light transmitter and the receiver unit including a light receiver which is arranged opposite the light transmitter.

The energy and/or the data can likewise be able to be transmitted inductively from the coupling device to the measurement circuit. Again alternatively to this, the energy and/or the data can be able to be transmitted optically from the coupling device to the measurement circuit, with the coupling device including a light transmitter and the measurement circuit including a light receiver which is arranged opposite the light transmitter.

The measurement data, the energy and/or the data can, however, generally also be transmitted capacitively, by radio or by infrared radiation. The respective transmitter and the respective receiver preferably each have an electrode for The capacitive transmission.

In a preferred embodiment, the lab stirrer includes a regulation unit in which the measurement data of the measurement parameter are used for the regulation of the measurement parameter and/or of other process parameters. A lab stirrer with a regulation unit can thus provide the functions of electronic contact thermometers (ECT) known today. The regulation unit in particular includes a simple desired/actual comparison. It can, for example, be made as a P controller or as a PID controller or it can include a fuzzy logic.

It is in particular preferred if the regulation unit generates an output signal which is used for the regulation of a device influencing the measurement parameter and/or the other process parameters, preferably of an external device, of a temperature control device and/or of a metering device, with the output signal preferably being transmitted via an interface. The measured temperature can, for example, serve as a regulation parameter to regulate a temperature control device which can be integrated in the lab stirrer or present in an external device. Alternatively or additionally to a temperature control device, for example a hot plate, a metering device, for example a metering pump for liquid metering, can also be regulated by the regulation unit. Other components of the process chain can likewise be regulated or controlled. The output signal can, for example, be a switch signal to switch the device on and/or off. The output signal can, however, also be a setting signal, in particular a proportional signal, to change a setting parameter of the device, in particular by a proportional factor.

The measurement data of the measurement parameter can preferably be transmitted via an interface of the lab stirrer.

The invention furthermore relates to a lab device having a lab stirrer such as has been explained above and having a container, in particular such as has been explained above, for the reception of the medium to be stirred.

The invention furthermore relates to a method for the stirring of a medium and for the measurement of measurement data of a measurement parameter of the medium in which a lab stirrer such as has been explained above is used. The stirring and the measurement preferably take place simultaneously.

The invention furthermore relates to the use of a stirring member of a lab stirrer which can be driven in a rotating manner by a stirring unit and is provided for immersion into a medium to be stirred, in particular to the use of an overhead stirrer, for the measurement of measurement data of a measuring parameter of the medium.

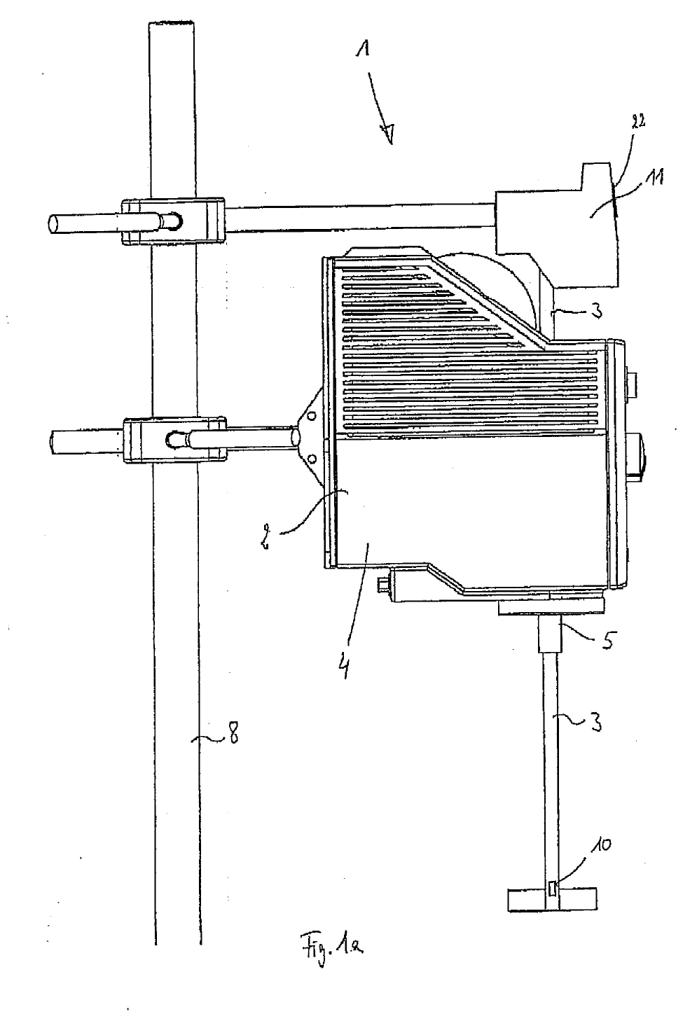

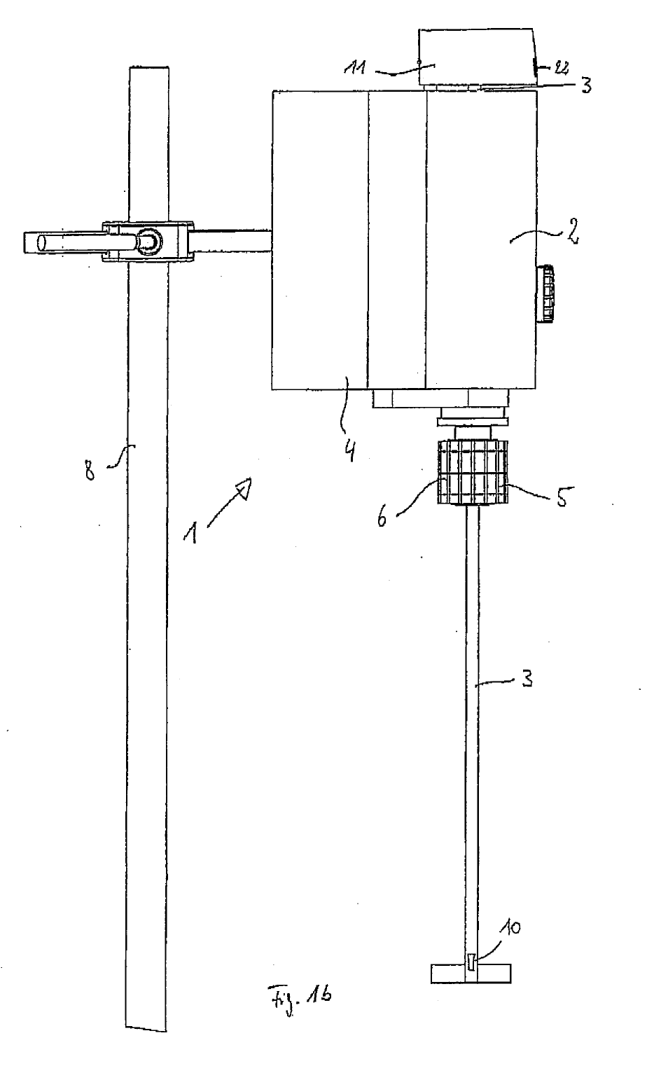

FIGS. 1a to 1c show three different embodiments of a lab stirrer 1 in accordance with the invention, in particular of an overhead stirrer, having a stirring unit 2 and a stirring shaft 3.

The stirring unit 2 is made such that the stirring shaft 3 can extend through the stirring unit 2. The stirring shaft 3 includes a measurement sensor 10 and a measurement circuit 9 connected to the measurement sensor 10 (FIG. 1c), with the measurement sensor 10 and the measurement circuit 9 in each case being integrated into the stirring shaft 3. The measurement data in particular measured by the measurement sensor 10 during the stirring of a medium are prepared in the stirring shaft 3 and transmitted to a receiver unit 11 of the lab stirrer 1. The measurement data, other data based on the measurement data and/or further information can be displayed at a display unit, e.g. a display 22.

The stirring unit 2 includes a stirring unit housing 4 in which a drive unit, not shown, is contained which includes a motor. The drive unit drives a rotatable holder 5 which holds the stiring shaft 3. The holder 5 is preferably made for the changeable holding of the stirring shaft 3. The stirring shaft 3 can thus be replaced easily. The stirring unit 2 can be operated with different stirring shafts 3. The holder 5 in FIG. 1b is a quick-action chuck 6 to allow a comfortable and simple replacement of the stirring shaft 3 without a tool The stirring shaft 3 can rotate, only by way of example, at up to 2000 r.p.m.

In the embodiments of the lab stirrer 1 described in FIGS. 1a to 1c, the measurement sensor 10 is made as a temperature sensor and the receiver unit 11 is made for temperature measurement. Only by way of example, the temperatures of the respective medium can lie between −30° C. and approximately +220° C. The receiver unit 11 can naturally also be made for the evaluation and processing of other physical parameters. The description with reference to a temperature measurement does not represent any restriction of the invention.

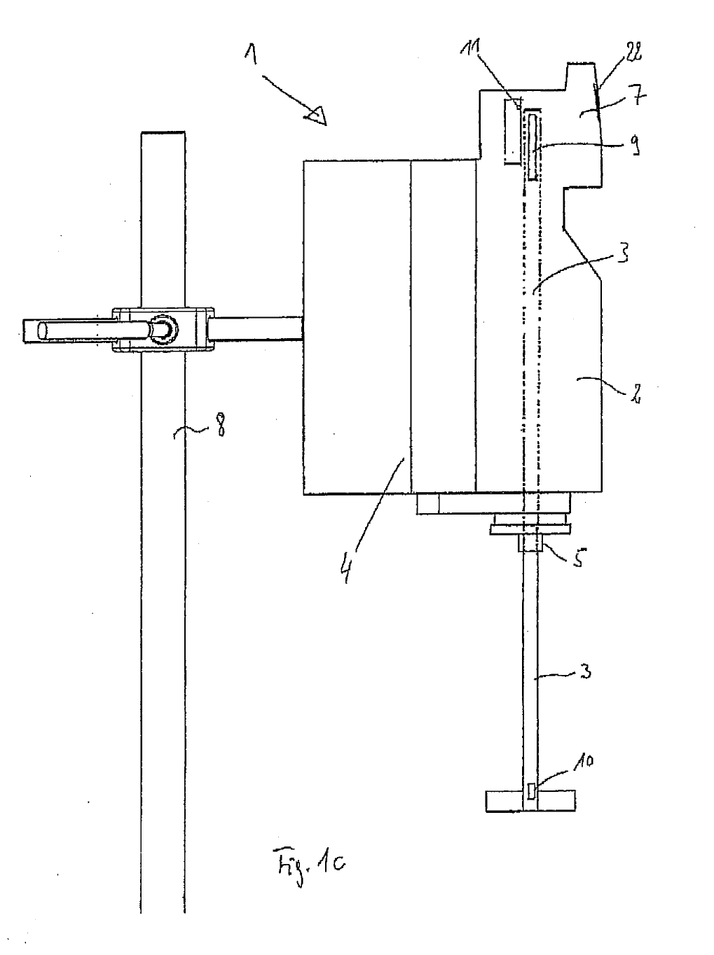

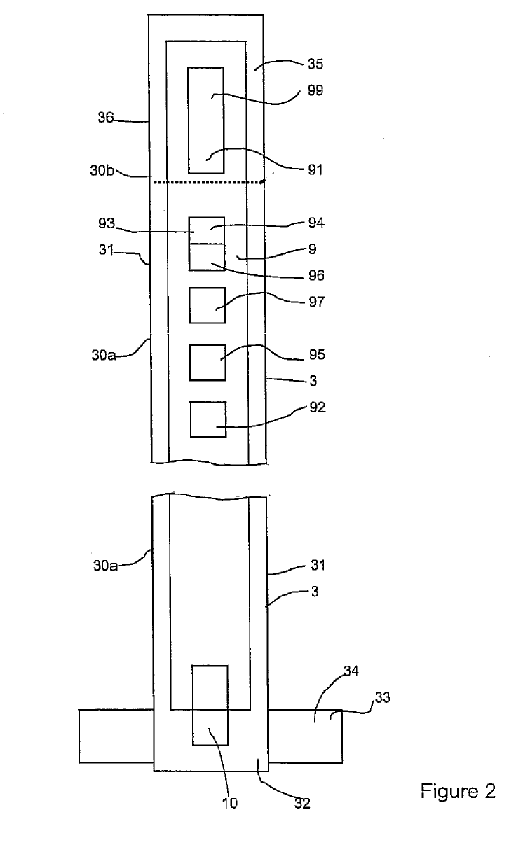

It is shown in FIG. 1c that the stirring shaft 3 includes the measurement circuit 9 and the measurement sensor 10 which measures the temperature in a medium to be stirred. The measurement sensor 10 transmits its measurement data to the measurement circuit 9 which includes a data transmission device 91 (FIG. 2), with the measurement data being prepared, processed, converted in parallel/serial, digitized and/or modulated in the measurement circuit 9,

The data processing device 91 preferably arranged in the upper end 35 of the stirring shaft 3 transmits the measurement data of the measurement sensor 10 to the receiver unit 11 in a contactless manner. The contactless data transmission has the advantage that the receiver unit 11 and the stiring shaft 3 can move relative to one another without mutual influencing. The receiver unit 11 does not rotate with the stirring shaft 3. It is preferably of fixed position. It can, however, also be movable, for example, can likewise rotate.

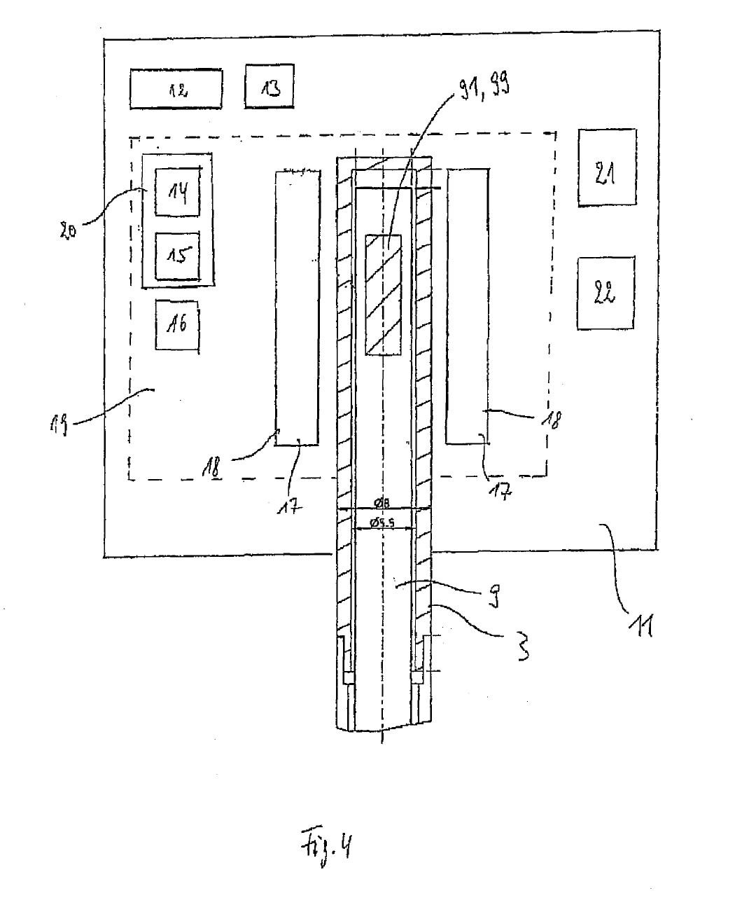

The receiver unit 11 serves not only for the reception of measurement data from the stirring shaft 3, but also for the supply of energy to the measurement circuit 9 of the stirring shaft 3. The receiver unit 11 can furthermore include a regulation unit 21 (FIG. 4) which uses the measurement data of the measurement parameter of the medium measured by the measurement sensor 10 and transmitted to the receiver unit 11 for the regulation of the measurement parameter of the medium and/or of other process parameters. In the measurement of the viscosity of the medium, for example, a metering device can be regulated by means of which a liquid is, for example, added to the medium to be stirred.

Both the measurement data and the output signal of the regulation unit 21 or further information such as the revolution speed or similar can be taken up via one or more interfaces at the lab stirrer 1, in particular at the stirring unit 2, preferably at the receiver unit 11. Only one interface is preferably present to pick up all data and signals of interest. A wireless transmission is likewise conceivable.

In FIG. 1a, the receiver unit 11 is made as a separate module. The receiver unit 11 and the stirring unit 2 are fastened to a stand 8 and are adjustable in their position, in particular their height, so that the receiver unit 11 can be arranged in dependence on the position and size of the stirring shaft 3 relative to the stirring unit 2. A simple matching to different stirring vessels and liquid amounts to be stirred and stirring shaft lengths can thus be carried out.

The separate receiver unit 11 has the advantage that already present stirring units 2 can be expanded by the receiver unit 11 and stirring shafts 3 can also be used with an integrated temperature sensor 10 in conventional stirring units 2.

The embodiment in accordance with FIG. 1b shows a receiver unit 11 which is placed onto the stirring unit housing 4. The stirring unit 2 and the receiver unit 11 are preferably integrated in a common housing. FIG. 1c shows a receiver unit 11 integrated into the stirring unit housing 4. A compact device is hereby formed which is made for the temperature measurement during the stirring by means of the stirring shaft.

In a preferred embodiment, the desired value, regulated to the regulation unit 21, can be set, The desired value can preferably be set at the regulation unit 21 itself or at the receiver unit 11. For this purpose, corresponding switches or buttons (e.g. press and turn controls) or a touch screen can be provided. The operating elements for the setting of the desired value can be integrated in the operating units of the lab stirrer, which can be the case, for example, with a touch screen operation.

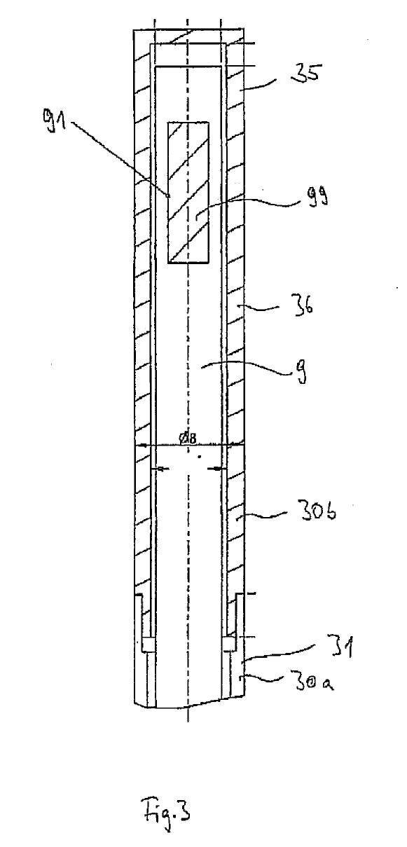

The stirring shaft 3 is shown in detail in FIGS. 2 and 3. It is made as a hollow shaft and, for example, has an outer diameter of 8 to 10 mm and an inner diameter of 4 to 8 mm. The stirring shaft 3 includes a first shaft section 30a and a second (shorter) shaft section 30b. The shaft section 30a of the stirring shaft 3 is preferably a stainless steel pipe 31 at whose lower end 32 (FIG. 2) a stirring element 33 is provided, with the lower end 32 being remote from the stirring unit 2 and being immersed into the medium to be stirred during the stirring. Optionally, the stirring element 33 can be changeably fastened to the stirring shaft 3; it is preferably integrated into the stirring shaft 3. The stirring element 33 can be made as a stirring vane 34 and can be fastened by means of a hexagonal bolt or a nut to be selected in dependence on the medium to be stirred. Stirring elements 33 known from the prior art can thus be fastened to the stirring shaft 3. It is also conceivable that the measurement sensor 10 is integrated into the stirring element 33. The stirring shaft 3 and the stirring element 33 represent a stirring member of the lab stirrer.

The shaft section 30b is arranged at the upper end 35 of the stirring shaft 3 which is disposed opposite the lower end 32, said shaft section preferably being made of a non-magnetic shaft piece 36, and in particular of a magnetically non-screening shaft piece, which is connected to the stainless steel pipe 31. The shaft piece 36 is preferably made of glass, ceramic material or artificial resin. The stirring shaft 3 is in this embodiment suitable for energy transmission and/or data transmission by means of a magnetic field.

It can be seen from FIG. 3 that the first shaft section 30a has a groove and the second shaft section 30b has a corresponding setback so that the two shaft sections 30a, 30 can be connected to one another rotationally fixedly in accordance with the tongue and groove principle. The connection of the two sections 30a, 30b does not allow any relative movement between them and is sealing such that at least no liquid can enter.

The measurement circuit 9 and the measurement sensor 10 are integrated in the interior of the stirring shaft 3. The measurement circuit 9 is integrated on an axially extending board at whose end the measurement sensor 10 is arranged. The sensor 10 naturally does not have to be integrated in the board. It can also be made as a separate component which is connected to the board by means of an electrical connection (cable). In this case, a conventional platinum sensor can be used, e.g. a PT 1000 sensor, to expand the preferred temperature range.

Measurement data of the temperature of the medium to be measured are transmitted from the measurement sensor 10 to the measurement circuit 9. The measurement circuit 9 includes the data transmission device 91 which transmits the measurement data of the measurement sensor 10 to the receiver unit 11 in a contactless manner, as is shown in FIG. 4.

The measurement circuit 9 includes measurement electronics 92 (FIG. 2) for the digitizing of the measurement signals and measurement data, a power pack 94 made as a voltage regulator, a microprocessor 95, a regulation circuit 96 and a modulator 97. The measurement electronics 92 can alternatively also be integrated in the measurement sensor 10, for example in a temperature sensor.

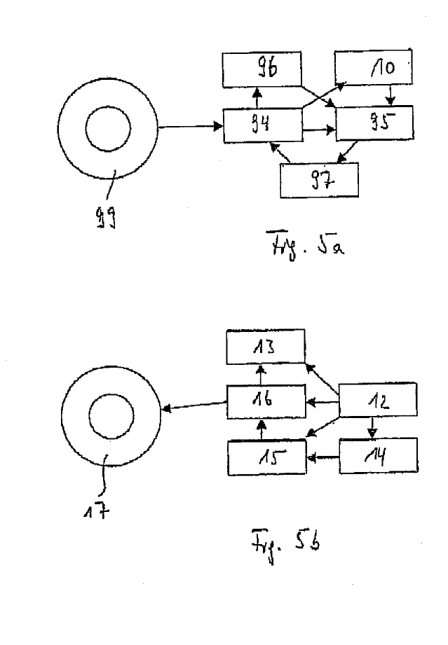

The regulation circuit 96 can, for example, start the microprocessor 95 as soon as a sufficient voltage supply of the measurement circuit 9 is provided by the power pack 94, as can be seen from the block diagram of FIG. 5a.

The receiver unit 11 includes a voltage supply 12, a microprocessor 13, a generator 14, a power part 15 and an amplifier 16. The schematic diagram of the receiver unit 11 is shown in FIG. 5b. The receiver unit 11 also has a transformer 18 made as a coil 17 to transmit energy and data to the stirring shaft 3 or to receive data from the stirring shaft 3. The coil 17 is preferably a cylindrical coil whose cylinder axis extends axially to the stirrer shaft 3 so that the stirring shaft 3 rotates within the coil 17, with a gap of at least 1 mm, preferably of at least 3 mm and particularly preferably of at least 5 mm, being formed between the coil 17 and the shaft 3.

Since the stirring shaft 3 does not have any energy source of its own, it has to be supplied with energy by the receiver unit 11. The transmission between the stirring shaft 3 and the receiver unit 11 preferably takes place inductively or by means of a magnetic field.

The stirring shaft 3 has a coil 99 at its upper end 35. The data transmission device 91 particularly preferably includes the coil 99. The stirring shaft 3 is therefore made in the region of the coil 99 of non-magnetic material, for example of the non-magnetic shaft piece 36. The coil 99 cooperates for the transmission of (electrical) energy and/or data with a magnetic field which is generated by a coupling device 19 of the receiver unit 11, in particular of a magnetic field source. The magnetic field source 19 does not rotate with the stirring shaft 3. The magnetic field source 19 is preferably integrated in the receiver unit 11, as shown in Figure 4. The magnetic field source 19 is, for example, formed by the coil 17, the generator 14, the power part 15 and the amplifier 16. The magnetic field source is shown in dashed lines in FIG. 4.

In a preferred embodiment, the magnetic field source 19 and the stirring unit 2 are arranged in a common housing. As shown in FIG. 1c, the stirring unit housing 4 forms a common housing for the stirring unit 2 and the receiver unit 11, with the receiver unit 11 including the magnetic field source 19.

The stirring shaft 3 is insertable so far into the rotating holder 5 that its upper end projects beyond the holder 5 in the axial direction and preferably extends into the stirring unit housing 4, particularly preferably up to and into the receiver unit 11.

The contactless energy transmission to the stirring shaft 2 can take place, for example, in that the coil 99 of the stirring shaft 3 is moved in a static magnetic field. The rotational movement of the stirring shaft 3 is carried out by means of the holder 5 of the stirring unit 2 driven by a drive unit.

An energy transmission to the stirring shaft 3 preferably takes place inductively, magnetically, electromagnetically and/or using an alternating magnetic field. For example, a permanent magnet could be rotated in the receiver unit 11 so that an alternating magnetic field arises, with the permanent magnet and the stirring shaft 3 carrying out a relative movement.

The magnetic field source 19 of the receiver unit 11 can include a coil for the (electromagnetic) generation of a magnetic field. The coil is identical to the coil 17 of the receiver unit 11 in a preferred embodiment.

In a preferred embodiment the coil 17 is fed for the generation of an alternating magnetic field by an alternating current which is generated by feed current electronics 20. The feed current electronics 20 can, for example, be formed from the generator 14 and the power part 15. The alternating current fed into the coil 17 generates an alternating magnetic field which induces a voltage in the coil 99 of the stirring shaft 3. It is advantageous with this embodiment that the stirring shaft 3 can also be supplied with energy when stationary or at low revolution speeds. As soon as sufficient energy has been transmitted into the stirring shaft 3, the measurement sensor 10 starts to measure the temperature. At the same time, the regulation circuit 96 starts the microprocessor 95 so that a processing of the measurement data and/or a transmission of the measurement data to the receiver unit 11 can also take place.

Alternatively to the inductive, electromagnetic and/or magnetic energy transmission, the energy transmission to the stirring shaft 3 could take place optoelectronically, for example by means of LEDs.

The transmission of the measurement data, in particular of the temperature data, from the stirring shaft 3 to the receiver unit 11 can likewise take place optoelectronically, for example by use of light or by non-visible light sources, e.g. by means of LEDs. The data transmission device 91 of the stirring shaft 3 can, for example, preferably include a light transmitter, for example a semiconductor light transmitter. This light transmitter can preferably be arranged at the insertion-side end face of the stirring shaft 3, that is at the upper end 35 at the end face. In this embodiment, the receiver unit 11 can include a light receiver which is arranged opposite the light transmitter of the stirring shaft 3 such that an optical transmission can take place between the light transmitter and the light receiver.

The data transmission between the stirring shaft 3 and the receiver unit 11 likewise preferably takes place inductively, magnetically and/or electromagnetically. For example, a magnetic field can be generated by the coil 99 of the stirring shaft 3, said magnetic field being received in the receiver unit 11 and its signal being evaluated. For this purpose, however, a separate energy supply in the stirring shaft 3 is necessary.

In a preferred embodiment, the measurement circuit 9 of the stirring shaft 3 works as a transponder, in particular as a so-called RFID transponder (radio frequency identification transponder). The alternating (electro)magnetic field generated by the magnetic source 19 induces a voltage in the coil 99 so that the associated induction current supplies the measurement circuit 9 with energy. The microprocessor 95 of the measurement circuit 9 generates a wanted signal which corresponds to the measured (digitized) measurement data of the temperature sensor 9. In this respect energy is consumed in the measurement circuit 9 in dependence on the measurement data and is detected in the receiver unit 11. The change of the energy consumption can take place, for example, by short-circuiting the coil 99. Since the measurement circuit 9 does not have any energy source of its own, it does not generate any magnetic field itself to transmit measured values actively to the receiver unit 11.

The measurement circuit 9 therefore includes the modulator 97 which is controlled by the microprocessor 95. The modulator 97 is controlled in dependence on the measurement signals measured by the measurement sensor 10.

The measurement data can e.g. be transmitted to the receiver unit 11 as a modulated signal, with the (digitized) measurement data being superimposed as a wanted signal on the carrier signal generated by the receiver unit 11.

It is determined by the modulator 97 how much energy is taken from the alternating magnetic field generated by the magnetic field source 19 by the coil 99. For this purpose, a (wanted) signal proportional to the (digitized) measurement data is generated. This wanted signal is superimposed on the unmodulated (carrier) signal of the alternating magnetic field of the magnetic field source 19. The energy amount removed from the measurement circuit 9 and its change have a feedback effect on the magnetic field source 19. The feedback effect is registered by the receiver unit 11. It can decode the modulated measurement signal from the change of the alternating field caused by the energy removal or from the feedback to the magnetic field source 19 and can deduce the modulated measurement values.

The measurement data can therefore in particular be transmitted by means of load modulation, i.e. if the coil 99 of the measurement circuit 9 acting as a transponder is located in the near field of the coil 17 of the receiver unit 11 acting as a reading device, the measurement circuit 9 removes energy from the magnetic field generated by the coil 17, whereby a voltage change is caused in the coil 17 acting as a reading antenna so that the transmission of the measurement data from the measurement circuit 9 to the receiver unit 11 is possible by a modulation of the current flowing through the coil 99 or of the impedance of the measurement circuit 9.

The spacing between the stirring shaft 3 and the receiver unit 11 is limited by the inductive coupling between the magnetic field source 19 or the receiver unit 11 and the measurement circuit 9 with the coil 99 in the near electromagnetic field. Since, however, the stirring shaft 3 extends into the receiver unit 11, this distance is of no importance. Due to the transponder technology used, both the magnetic field source 19 and the receiver unit 11 could be some centimeters away from the stirring shaft 3. However, the energy and data transmission would require a higher magnetic field.

The use of an alternating electromagnetic field or of an alternating magnetic field, but also the use of an REID transponder have the advantage that a transmission of data and/or energy can also take place with a stationary stirring shaft 3. The stirring shaft 3 can consequently be at rest for its operation and in particular for the determination and transmission of the measurement data. It can naturally also rotate. The position, location or revolution speed of the stirring shaft 3 has no influence on the measurement or transmission of the measurement data to the receiver unit 11.

1. A lab stirrer comprising a stirring unit (2) and having a stirring member (3, 33) which can be driven in a rotating manner by the stirring unit (2) and is provided for immersion into a medium to be stirred, wherein the stirring member (3, 33) is provided with at least one measurement sensor (10) for the measurement of measurement data of a measurement parameter of the medium, with the stirring member (3, 33) being provided with a measurement circuit (9) which includes a data transmission unit (91) to transmit the measurement data in a contactless manner to a receiver unit (11) not rotating with the stirring member (3, 33).

2. A lab stirrer in accordance with claim I in the form of an overhead stirrer.

3. A lab stirrer in accordance with claim 1, wherein energy, data, or a combination thereof are transmitted from a coupling device (19) to the measurement circuit (9).

4. A lab stirrer in accordance with claim 1, wherein energy, data, or a combination thereof are transmitted in a contactless manner, from a coupling device (19) to the measurement circuit (9).

5. A lab stirrer in accordance with claim 1, wherein energy, data, or a combination thereof are transmitted from the receiver unit (11), to the measurement circuit (9).

6. A lab stirrer in accordance with claim 1, wherein the stirring unit (2) includes a holder (5) which can be rotatingly driven by a drive unit for the holding of the stirring member (3, 33), with the holder (5) being made for the changeable holding of the stirring member (3, 33).

7. A lab stirrer in accordance with claim 6, wherein the stirring unit (2) includes a holder which can be rotatingly driven by a drive unit for the holding of the stirring member (3, 33) during the stirring.

8. A lab stirrer in accordance with claim 1, wherein the measurement sensor (10) is a temperature sensor and the measurement data are temperature data.

9. A lab stirrer in accordance with claim 1, wherein the stirring member (3, 33) includes a stirring shaft (3), wherein the stirring member (3, 33) additionally includes a stirring element (33) or a combination thereof.

10. A lab stirrer in accordance with claim 9, wherein the stirring shaft (3) is made as a hollow shaft in whose interior the measurement sensor (10) is arranged.

11. A lab stirrer in accordance with claim 9, wherein the stirring element (33) has at least one stirring vane (34).

12. A lab stirrer in accordance with claim 9, wherein the stirring element (33) is changeably fastenable to the stirring shaft (3).

13. A lab stirrer in accordance with claim 1, wherein the data transmission unit (91) is made for the digital transmission of the measurement data.

14. A lab stirrer in accordance with claim 1, wherein the measurement circuit (9) includes a coil (99).

15. A lab stirrer in accordance with claim 14, wherein the coil (99) is provided at the end (35) of the stirring member (3, 33) disposed opposite the end (32) provided for immersion into the medium to be stirred.

16. A lab stirrer in accordance with claim 14, wherein the coil (99) cooperates with a magnetic field which is generated by the receiver unit (11).

17. A lab stirrer in accordance with claim 1, wherein the receiver unit (11) includes a coil (17) for the generation of a magnetic field.

18. A lab stirrer in accordance with claim 1, wherein the coil (17) for the generation of a magnetic field is connected to feed current electronics (20) for the generation of an alternating magnetic field, said feed current electronics feeding alternating current into the coil (17).

19. A lab stirrer in accordance with claim 1, wherein the measurement data is transmitted inductively from the data transmission unit (91) to the receiver unit (11).

20. A lab stirrer in accordance with claim 19, wherein the measurement data is transmitted from the data transmission unit (91) to the receiver unit (11) by load modulation.

21. A lab stirrer in accordance with claim 1, wherein the measurement data can be transmitted optically from the data transmission unit (91) to the receiver unit ( 1), with the data transmission unit (91) including a light transmitter and the receiver unit (11) including a light receiver which is arranged opposite the light transmitter

22. A lab stirrer in accordance with claim 1, wherein energy, data, or a combination thereof are transmitted inductively from a coupling device (19) to the measurement circuit (9).

23. A lab stirrer in accordance with claim 1, wherein energy, data, or a combination thereof are transmitted optically from a coupling device (19) to the measurement circuit (9), with the coupling device (19) including a light transmitter and the measurement circuit (9) including a light receiver which is arranged opposite the light transmitter.

24. A lab stirrer in accordance with claim 17 wherein the lab stirrer (1) includes a regulation unit (21) in which the measurement data of the measurement parameter are used for the regulation of at least one of the measurement parameter and other process parameters.

25. A lab device having a lab stirrer (1) and having a container for the reception of a medium to be stirred, the lab stirrer (1) having a stirring unit and having a stirring member (3, 33) which is driven in a rotating manner by the stirring unit (2) and is provided for immersion into the medium to be stirred, wherein the stirring member (3, 33) is provided with at least one measurement sensor (10) for the measurement of measurement data of a measurement parameter of the medium, with the stirring member (3, 33) being provided with a measurement circuit (9) which includes a data transmission unit (91) to transmit the measurement data in a contactless manner to a receiver unit (11) not rotating with the stirring member (3, 33).

26. A method for the stirring of a medium and for the measurement of measurement data of a measurement parameter of the medium in which a lab stirrer (1) having a stirring unit (2) and having a stirring member (3, 33) which is driven in a rotating manner by the stirring unit (2) and is provided for immersion into a medium to be stirred, wherein the stirring member (3, 33) is provided with at least one measurement sensor (10) for the measurement of measurement data of a measurement parameter of the medium, with the stirring member (3, 33) being provided with a measurement circuit (9) which includes a data transmission unit (91) to transmit the measurement data in a contactless manner to a receiver unit (11) not rotating with the stirring member (3, 33), with the stirring and measurement taking place simultaneously or non-simultaneously.
